(19) United States
(12) Patent Application Publication
(10) Pub. No.: US 2025/0105404 A1
(43) Pub. Date: Mar. 27, 2025

(54) SECONDARY BATTERY

(71) Applicant: Samsung SDI Co., Ltd., Yongin-si (KR)

(72) Inventor: Seong Hun JEONG, Yongin-si (KR)

(21) Appl. No.: 18/763,779

(22) Filed: Jul. 3, 2024

(30) Foreign Application Priority Data
Sep. 26, 2023 (KR) 10-2023-0129002

(51) Int. Cl. H01M 50/105

(52) U.S. Cl. CPC H01M 50/105

(57) ABSTRACT

A secondary battery includes: an electrode assembly having a positive electrode plate, a negative electrode plate, and a separator between the positive electrode plate and the negative electrode plate; a pouch having an inner space in which the electrode assembly is accommodated; a flat part forming a plane on an end of the pouch; and a guide part installed around the flat part and having a shape that protrudes further than the flat part.

### CROSS-REFERENCE TO RELATED APPLICATION

The present application claims priority to and the benefit of Korean Patent Application No. 10-2023-0129002, filed on Sep. 26, 2023, in the Korean Intellectual Property Office, the entire disclosure of which is incorporated herein by reference.

### BACKGROUND

### 1. Field

Aspects of some embodiments relate to a secondary battery.

### 2. Description of the Related Art

In a secondary battery, a positive electrode, a negative electrode, and a separator interposed between the positive electrode and the negative electrode may be wound or stacked to provide an electrode assembly and then may be accommodated together with an electrolyte in a can or pouch to be sealed.

Generally, an electrode assembly may include a negative electrode plate on which a negative electrode active material layer is located or formed on a thin film-shaped electrode current collector and a positive electrode plate on which a positive electrode active material layer is located or formed on a thin film-shaped electrode current collector. A non-coated portion on which the active material layer is not located may be located on each of the negative electrode plate and the positive electrode plate, and then, the non-coating portion may be processed to provide a plurality of base material tabs. The plurality of base material tabs may be gathered to one side of the electrode assembly and welded to an external tab such as a strip terminal and then be bent to be inserted into the pouch.

Secondary batteries are manufactured in various shapes. Among them, a pouch-type secondary battery includes an electrode assembly provided by interposing a separator that is an insulator between a positive electrode plate and a negative electrode plate and a thin flexible pouch in which the electrode assembly is embedded. Here, the pouch may accommodate the electrode assembly in an inner space provided by bonding of an edge portion.

The pouch may be made of a material that is relatively easily deformed, and if charging and discharging of the pouch-type secondary battery is repeated, an electrolyte within the pouch may be consumed to cause a phenomenon in which the pouch facing an end of the electrode assembly is suctioned in a direction toward the electrode assembly.

The above information disclosed in this Background section is only for enhancement of understanding of the background and therefore the information discussed in this Background section does not necessarily constitute prior art.

### SUMMARY

Aspects of some embodiments relate to a secondary battery that may improve a phenomenon in which an end of the pouch is suctioned inward.

Aspects of some embodiments of the present disclosure include a secondary battery that may be capable of preventing or reducing the occurrence of a phenomenon, in which an end of a pouch is suctioned inward.

Other aspects of some embodiments of the present disclosure include a secondary battery that may be capable of maintaining a phenomenon in which a shape of a pouch is maintained even if an electrolyte within the pouch is reduced.

The object to be solved through the embodiments are not limited to the above-mentioned problems, and other objects not mentioned herein will be clearly understood by those skilled in the art from this specification and the attached drawings.

According to some embodiments, a secondary battery includes: an electrode assembly provided with a positive electrode plate, a negative electrode plate, and a separator between the positive electrode plate and the negative electrode plate; a pouch configured to provide an inner space in which the electrode assembly is accommodated; a flat part configured to define a plane on an end of the pouch; and a guide part installed around the flat part and having a shape that further protrudes than the flat part.

According to some embodiments, a tab may be arranged in a direction of one side of the electrode assembly, and the flat part and the guide part may be arranged in a direction of the other side of the electrode assembly, which is a direction opposite to the tab.

According to some embodiments, the flat part may be configured to define the plane in at least one of a circular, oval, polygonal, triangular, square, or rhombus shape.

According to some embodiments, the flat part may be provided in plurality, which are installed to be spaced apart from each other with the guide part therebetween.

According to some embodiments, the flat part may be provided in plurality, which are installed successively in a width direction of the pouch.

According to some embodiments, the flat part may be arranged in a plurality of rows, which are installed successively in a width direction of the pouch.

According to some embodiments, the flat part may extend in a width direction of the pouch and has a rectangular shape.

According to some embodiments, the guide part may include: an upper guide above the flat part to extend in the width direction of the pouch; a lower guide facing the upper guide with the flat part therebetween; a first side facing an end of one side of the flat part and configured to connect the upper guide to the lower guide; and a second side facing an end of the other side of the flat part and configured to connect the upper guide to the lower guide.

According to some embodiments, a length of the upper guide in a vertical direction is T1, a length of the lower guide in the vertical direction is T3, a length of the first side in the width direction is T4, and a length of the second side in the width direction is T5, T1 and T3 may be the same, and T4 and T5 may be the same.

According to some embodiments, a length of the upper guide in a vertical direction is T1, a length of the flat part in the vertical direction is T2, a length of the lower guide in the vertical direction is T3, and a length of the pouch in the vertical direction is MT, equation: MT=T1+T2+T3 may be satisfied.

According to some embodiments, a length of the upper guide in a vertical direction is T1, a length of the flat part in the vertical direction is T2, a length of the lower guide in the vertical direction is T3, and a length of the pouch in the vertical direction is 100, T1 is set to a value of approximately 1 to approximately 10, T2 may be set to a value of approximately 80 to approximately 98, and T3 may be set to a value of approximately 1 to approximately 10.

According to some embodiments, a length of the flat part in the width direction is PW, a length of the first side in the width direction is T4, a length of the second side in the width direction is T5, and a length of the pouch in the width direction is MW, equation: MW=PW+T4+T5 may be satisfied.

According to some embodiments, a length of the pouch in the width direction is 100, T4 is set to a value of approximately 1 to approximately 10, PW may be set to a value of approximately 80 to approximately 98, and T5 may be set to a value of approximately 1 to approximately 10.

According to some embodiments, a secondary battery includes: an electrode assembly provided with a positive electrode plate, a negative electrode plate, and a separator between the positive electrode plate and the negative electrode plate; a pouch configured to provide an inner space in which the electrode assembly is accommodated; a flat part configured to define a plane on an end of the pouch; and a guide part installed around the flat part and having a shape that further protrudes than the flat part, wherein the flat part has rigidity greater than that of the pouch.

According to some embodiments, the guide part may have rigidity greater than that of the pouch.

According to some embodiments, the pouch, the flat part, and the guide part may be molded to be integrated with each other.

According to some embodiments, the flat part may be fixed to an end of the electrode assembly.

According to some embodiments, the flat part may include: an internal adhesive layer adhering to an end of the other side of the electrode assembly; and a flat body fixed to the internal adhesive layer and connected to the pouch.

According to some embodiments, the internal adhesive layer may include any one of a thermosetting adhesive, a silicone adhesive, an acrylate adhesive, a urethane adhesive, a resin, and a rubber adhesive.

According to some embodiments, the internal adhesive layer may have an area equal to or less than that of the other end of the electrode assembly.

### BRIEF DESCRIPTION OF THE DRAWINGS

The following drawings attached in this specification illustrate aspects of some embodiments of the present invention and function to make further understood aspects of some embodiments of the present invention along with the detailed description of the invention, and thus, the present invention should not be construed as being limited to only the drawings;

FIG. 1 illustrates a perspective view of a secondary battery according to some embodiments;

FIG. 2 illustrates an exploded perspective view of the secondary battery according to some embodiments;

FIG. 3 illustrates a side cross-sectional view of the secondary battery according to some embodiments;

FIG. 4 illustrates a side view of the secondary battery according to some embodiments;

FIG. 5 illustrates a cross-sectional view of a flat part and a guide part according to some embodiments;

FIGS. 6 to 11 illustrate a side view of a secondary battery according to other some embodiments;

FIG. 12 illustrates a cross-sectional view of a state in which a flat part is folded to an electrode assembly according to some embodiments; and

FIG. 13 illustrates a cross-sectional view of a detailed configuration of the flat part according to some embodiments.

### DETAILED DESCRIPTION

Hereinafter, aspects of some embodiments of the present disclosure will be described below in more detail with reference to the accompanying drawings. The terms used in the following description and claims are not limited to their dictionary meanings, but, are merely used to enable a clear and consistent understanding of the invention. Accordingly, it should be apparent to those skilled in the art that the following description of embodiments of the present invention is provided for illustration purpose only and not for the purpose of limiting the invention as defined by the appended claims and their equivalents. Thus, because the embodiments described in this specification and the configurations shown in the drawings illustrate aspects of some embodiments of the present invention and do not represent all of the technical ideas of the present invention, it should be understood that there may be various equivalents and modifications that can be substituted for them at the time of this application. Also, the expressions “comprise/include” and/or “comprising/including” used in this specification neither define the mentioned shapes, numbers, steps, operations, members, elements, and/or groups of these, nor exclude the presence or addition of one or more other different shapes, numbers, steps, operations, members, elements, and/or groups of these, or addition of these. The term “and/or” used herein includes any and all combinations of one or more of the associated listed items.

In addition, the shapes and the sizes of elements in accompanying drawings will be exaggerated for more apparent description. In addition, the same reference numbers may be assigned to the same components in different embodiments.

The reference to two objects of comparison being ‘the same’ means ‘substantially the same.’ Therefore, substantially identical may include a deviation that is considered to a low level in the art, for example, a deviation of less than 5%. In addition, uniformity of a parameter on a certain area may mean uniformity from an average perspective.

It will be understood that although the terms of first and second are used herein to describe various elements, these elements should not be limited by these terms. These terms are only used to distinguish one component from another component, and unless specifically stated to the contrary, the first component may also be a second component.

Throughout this specification, unless specifically referred to the contrary, each component may be singular or plural.

An arrangement of any component on an upper portion (or lower portion) of a component or on a top (or bottom) of a component means that any component is placed in contact with a top surface (or bottom surface of the component, as well as other elements are interposed between the element and any element located above (or below) the element.

In addition, if a component is described as being linked, coupled, or connected to another component, it should be understood that the above components may be directly connected or connected to each other, but other components may be “interposed” between each component, or each component may be linked, coupled, or connected through another component.

That is, throughout the specification, if referring to “A and/or B”, this means A, B or A and B, unless there is a special statement to the contrary, and if referring to “C to D”, this means C or higher and D or lower, unless specifically stated to the contrary.

A secondary battery 100 according to some embodiments will be described in more detail with reference to the drawings.

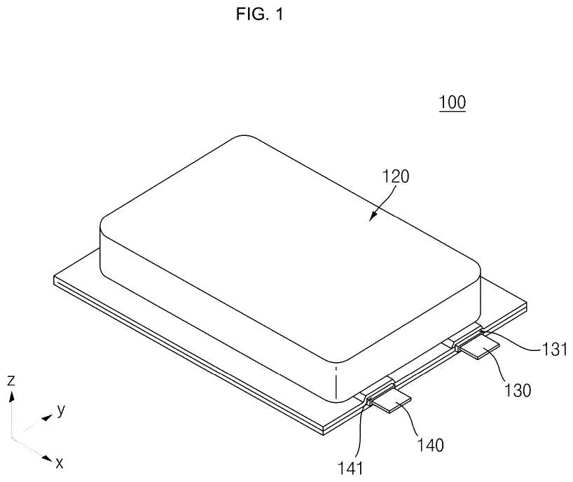

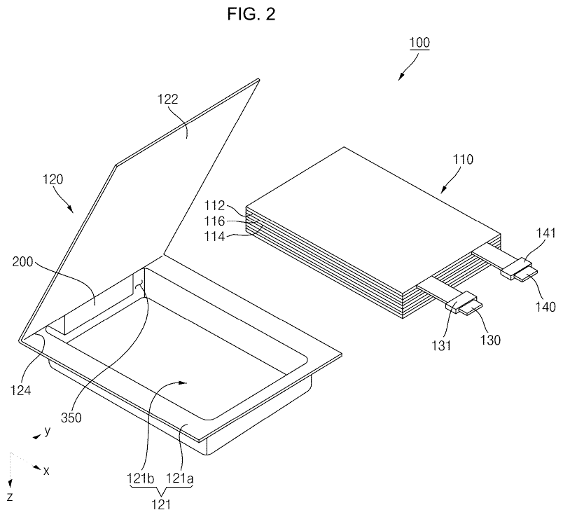

FIG. 1 illustrates a perspective view of a secondary battery according to some embodiments, and FIG. 2 illustrates an exploded perspective view of the secondary battery according to some embodiments.

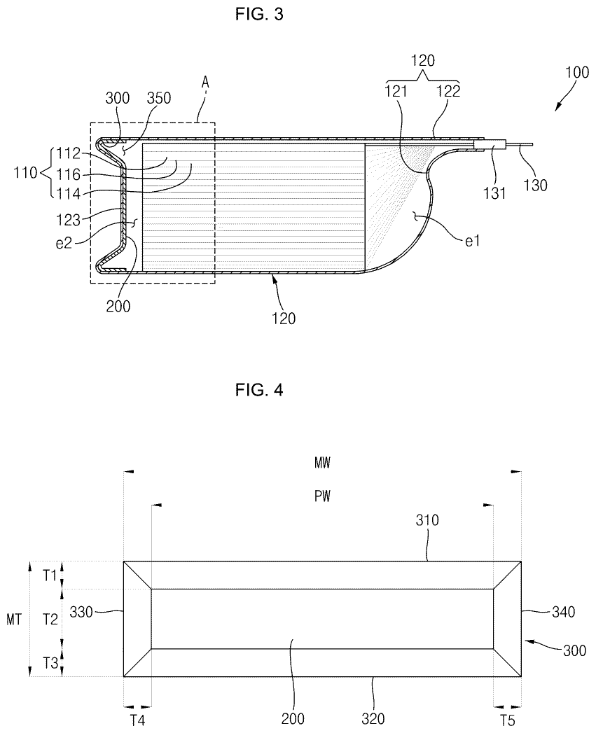

As shown in FIGS. 1 and 2, the secondary battery 100 may include an electrode assembly 110, a pouch 120, a flat part 200, and a guide part 300. According to some embodiments, the secondary battery 100 may further include at least one of a positive electrode lead tab 130, a negative electrode lead tab 140, a first insulating tape 141, or a second insulating tape 131. The secondary battery 100 according to some embodiments may add the flat part 200 (see, e.g., FIG. 2) and the guide part 300 (see, e.g., FIG. 3) in an inner space defined between the electrode assembly 110 and the pouch 120 to suppress a phenomenon in which a lower portion of the pouch 120 is suctioned.

The secondary battery 100 according to some embodiments may have a folded structure that is capable of controlling deformation of the pouch 120 in a regular manner so that the pouch 120 is induced to be deformed in the regular (or desirable) manner. The folded structure may be defined or controlled by the flat part 200 and the guide part 300. The flat part 200 may have at least one non-bent planar shape. The flat part 200 may be installed or formed to prevent the pouch 120 from being deformed to the inside of the secondary battery 100 to interfere with the electrode assembly 110.

The flat part 200 may be made of various materials such as a metal, a metal composite, oxide, and a polymer. According to some embodiments, the flat part 200 may be made of the same material as the pouch 120 or may be made of a material that is less prone to bending than the pouch 120 because the flat part 200 has rigidity greater than that of the pouch 120. That is, the pouch 120 may be relatively more flexible than the flat part 200. According to some embodiments, the flat part 200 may be modified in various manners, such as being fixed to at least one of the electrode assembly 110 or the inside of the pouch 120. According to some embodiments, a cross-section of the flat part 200 may be plate-shaped or planar, and various modifications may be made, such as being made of a porous material. The flat part 200 may be made of a porous polymer for impact absorption and gas movement, and a porous adhesive having pores may be applied to at least one of a front or rear surface of the flat part 200. According to some embodiments, there may or may not be an empty space between the electrode assembly 110 and the flat part 200.

The electrode assembly 110 may be provided in a stacked type or arrangement in which a negative electrode plate 112, a positive electrode plate 114, and a separator 116 are alternately stacked or may be provided in a roll shape or arrangement in which the negative electrode, the positive electrode, and the separator 116 are wound or rolled (e.g., into a cylindrical shape). The electrode assembly 110 according to some embodiments of the present disclosure may be accommodated in the pouch 120 and be provided with the positive electrode plate 114, the negative electrode plate 112, and the separator 116 located between the positive electrode plate 114 and the negative electrode plate 112, and also, the tab may be arranged in one direction.

The electrode assembly 110 may be accommodated inside the pouch 120 together with the electrolyte. The electrolyte may include an organic solvent such as ethylene carbonate (EC), propylene carbonate (PC), diethyl carbonate (DEC), ethyl methyl carbonate (EMC), and dimethyl carbonate (DMC), and lithium salt such as LiPF6 or LiBF4.

The electrode assembly 110 may include the negative electrode plate 112 as a first electrode plate, the positive electrode plate 114 as a second electrode plate, and the separator 116 located between the positive electrode plate 114 and the negative electrode plate 112. A positive electrode lead tab 130 electrically connected to a positive electrode non-coating portion may be provided on the positive electrode plate 114, and a negative electrode lead tab 140 electrically connected to a negative electrode non-coating portion may be provided on the negative electrode plate 112. The negative electrode lead tab 140 and the positive electrode lead tab 130 may be electrically connected to the outside by being welded to negative and positive electrode leads of an external terminal. A first insulating tape for insulating from the pouch 120 may be attached to the negative electrode lead tab 140, and a second insulating tape may be attached to the positive electrode lead tab 130 for insulating from the pouch 120.

The positive electrode plate 114 may be provided in a plate or planar shape and made of a conductive material such as aluminum (Al), and a positive electrode active material made of transition metal oxide may be applied on at least one surface of the positive electrode plate 114. In addition, the positive electrode plate 114 may be provided with the positive electrode non-coating portion, which is not coated with the positive electrode active material, at one side thereof.

The negative electrode plate 112 may be coated with the negative electrode active material such as graphite or carbon on at least one surface of the plate-shaped negative electrode plate 112 made of copper (Cu) or nickel (Ni). In addition, the negative electrode plate 112 may be provided with the negative electrode non-coating portion, which is not coated with the negative electrode active material, at one side thereof.

The separator 116 may be made of polyethylene (PE) or polypropylene (PP), but the embodiment is not limited thereto. The separator 116 may prevent the electrical short between the positive electrode plate 114 and the negative electrode plate 112 from occurring to allow the lithium ions to move only.

The pouch 120 may have a space defined therein and may be modified into various shapes within the technical idea of surrounding the electrode assembly 110. The pouch 120 may be made of a soft film. The pouch 120 may be provided by folding a rectangular film extending in a first direction x to provide a case body 121 and a case cover 122.

The pouch 120 according to some embodiments of the present disclosure may include the case body 121, the case cover 122, a connection film 123, and a folding part 124. After the electrode assembly 110 is accommodated in a recess 121b provided in the case body 121, the case cover 122 may rotate around the folding part 124 and coupled to the case body 121 and be sealed.

The case cover 122, which is a rectangular film extending in the first direction x, may rotate with respect to the folding part 124 extending in a second direction y that is a width direction y of the pouch 120, which is perpendicular to the first direction x. According to some embodiments, the case body 121 and the case cover 122 may be provided as individual members. According to some embodiments, the folding part 124 may not be provided. According to some embodiments, the pouch 120 may not be limited to the integrated type in which the case body 121 and the case cover 122 are provided on a single film. However, hereinafter, for convenience of explanation, an example in which the case body 121 and the case cover 122 are located on one rectangular film will be described, but embodiments according to the present disclosure are not limited thereto.

The first direction and the longitudinal direction used in the present disclosure may be an x-axis direction, the second direction and the width direction may be a y-axis direction, and the third direction and the vertical direction may be a z-axis direction.

According to some embodiments, the case body 121 may include the recess 121b and a sealing part 121a. The case body 121 may be provided with the recess 121b in which the electrode assembly 110 is accommodated approximately at a center thereof and may include the sealing part 121a extending approximately outward from three sides of the recess 121b. According to some embodiments, the sealing part 121a may extend outward from four sides of the recess 121b.

The sealing part 121a may be a surface parallel to and coupled to the case cover 122. For example, if the case body 121 and the case cover 122 are provided as individual members, the sealing part 121a may also be provided on an area on which the folding part 124 is located. According to some embodiments, even if the case body 121 and the case cover 122 are integrated with each other, the sealing part 121a may also be provided on the case body 121 adjacent to the folding part 124. However, for convenience of explanation, a case in which the sealing part 121a is not provided on the case body 121 adjacent to the folding part 124 will be described.

The case cover 122 and the case body 121 may be made of a multi-layer thin film constituted by a metal thin film and an insulating layer located on each of one surface and the other surface of the metal thin film. The case cover 122 and the case body 121 may define a surface on which the case cover 122 and the case body 121 are in contact with each other as an inner side, and an opposite surface as an outer surface.

The recess 121b of the case body 121 may be provided to a size at which the electrode assembly 110 is capable of being accommodated through press or drawing processing. In the case body 121, after a portion in which the recess 121b is defined is covered by the case cover 122, an edge of the recess 121b and an edge of the case cover 122 may be thermally fused to each other. In the pouch 120, after the electrode assembly 110 is accommodated in the recess 121b, an edge area of the case body 121 and an edge area of the case cover 122 may be sealed to each other.

For convenience, the edge of the case body, which is located outside on a plane with respect to a center of the recess 121b that is sealed with the edge of the case cover 122 may be defined as the sealing part 121a. An inner surface of the pouch 120 may be provided as a thermally fused layer that is made of a thermally fusible material.

The case cover 122 may have a rectangular flat shape. The case cover 122 may be connected to the case body 121 through the folding part 124. The case cover 122 may cover an upper portion of the case body 121.

FIG. 3 illustrates a side cross-sectional view of the secondary battery 100 according to some embodiments. As illustrated in FIG. 3, the flat part 200 may be deformed into various shapes within the technical ides that the flat part 200 is installed between the pouch 120 and the electrode assembly 110 to support the inside of the pouch 120 and induce deformation of the pouch 120 so that the pouch 120 is not in contact with an end of the electrode assembly 110.

In the secondary battery 100 according to some embodiments of the present disclosure, the tab may be arranged in a direction of one side of the electrode assembly 110, and the flat part 200 and the guide part 300 may be arranged in a direction of the other side of the electrode assembly 110, which is a direction opposite to the tab. The flat part 200 may be installed in a shape that surrounds the other end of the electrode assembly 110. According to some embodiments, a second space e2 may be defined between the flat part 200 and the other end of the electrode assembly 110. A first space e1, which is opposite to the second space e2, may be defined between the electrode assembly 110 and the pouch 120.

The pouch 120 facing the flat part 200 may provide the connection film 123. The connection film 123 may function to connect the case cover 122 to the case body 121. The connection film 123 may be made of a material having the same ductility as that of the other pouch 120.

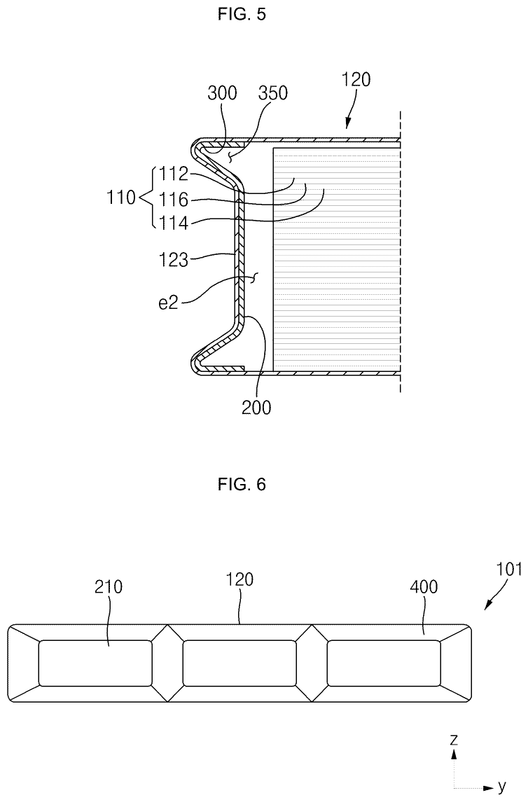

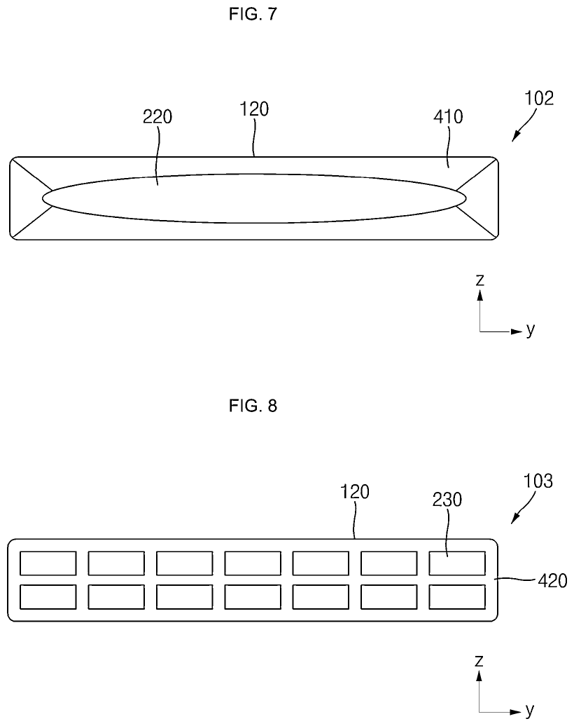

FIG. 4 illustrates a side view of the secondary battery 100 according to some embodiments, and FIG. 5 illustrates a cross-sectional view of the flat part 200 and the guide part 300 according to some embodiments. FIG. 5 is an enlarged cross-sectional view of a portion “A” in FIG. 3.

As illustrated in FIGS. 3 to 5, the flat part 200 may be deformed into various shapes within the technical idea of defining a plane at the end of the pouch 120. The flat part 200 may have a planar shape (e.g., in the y direction) and have at least one of a circle, oval, polygon, triangle, square, or rhombus shape (e.g., when viewed in the x direction). The flat part 200 according to some embodiments may extend in the width direction y of the pouch 120 and may have a rectangular shape.

The rigidity of the flat part 200 may be greater than that of the pouch 120. Because the rigidity of the pouch 120 is weaker than that of the flat part 200, if external force is applied, the pouch 120 may be more likely to be deformed than the flat part 200. Therefore, if the end of the pouch 120 is about to be deformed toward the inside of the pouch 120 due to a lack of the electrolyte, the deformation of the end of the pouch 120 may be prevented or minimized by the flat part 200.

The pouch 120, the flat part 200, and the guide part 300 may be molded to be integrated with each other. The pouch 120, the flat part 200, and the guide part 300 may be made of the same material and may be integrated with different thicknesses. For example, if the thickness of the pouch 120 is 1, each of the flat part 200 and the guide part 300 may have a thickness greater than 1 and thus may be less deformed than the pouch 120.

According to some embodiments, if the pouch 120, the flat part 200, and the guide part 300 are made of different materials, the flat part 200 and the guide part 300 may be installed inside the pouch 120.

The flat part 200 may be installed at a position facing the end of the electrode assembly 110 on which no terminal is located, and the second space e2 may be defined between the flat part and the end of the electrode assembly 110. Because the flat part 200 is made of a material that is less ductile or less deformable than the pouch 120, if external force is applied, the deformation of the pouch 120 may be greater than that of the flat part 200.

The flat part 200 may be made of the same material as the pouch 120, and, in some embodiments, may be made of a film material with rigidity higher than that of the pouch 120. According to some embodiments, the flat part 200 may be provided in a plate shape with little deformation. The connection film 123 of the pouch 120 may be located outside the flat part 200, and in some embodiments, the pouch 120 may be implemented in various modifications, such as being connected to the end of the flat part 200 without the pouch 120 is not installed outside the flat part 200.

According to some embodiments, the flat part 200 may be made of a porous material. According to some embodiments, the flat part 200 may have pores defined using a porous polymer. According to some embodiments, the flat part 200 may be made of porous alumina, ceramic such as silica, a porous polymer material such as polypropylene (PP), a porous synthetic resin, or the like. According to some embodiments, because a portion of the electrolyte exists in the pores of the flat part 200, a lifespan of the secondary battery 100 may increase. A shape of the pore defined in the flat part 200 may be generated randomly or regularly.

According to some embodiments, the flat part 200 may include any one of porous alumina, porous silica, porous ceramic, a porous polymer, a porous metal, a porous nanomaterial, porous sponge, a porous synthetic resin, and a porous polymer.

Porous alumina may have excellent fire resistance and corrosion resistance and may be used as an electrical insulator. Porous silica may have a high surface area and may be used as a catalyst carrier or used as a separator and for filtering and adsorption. Porous ceramics may be used as thermal and electrical insulators and may be used in environments in which fire resistance and corrosion resistance are required. Porous polymers may be lightweight and chemically stable and may be used in various fields such as medical materials, separators, and sound absorbing materials. Porous metals may be used as solid catalysts or gas adsorption materials and may also act as catalysts in chemical reactions. Porous nanomaterials may be nano-structured porous materials that have special physical and chemical properties and may be used in catalysts, sensors, and medical applications.

The flat part 200 according to some embodiments may be located between the pouch 120 and the electrode assembly 110. According to some embodiments, the flat part 200 may be made of a porous material that supports the inside of the pouch 120 and defines a space therein.

The guide part 300 may be installed around the flat part 200 and may be deformed into various shapes within the technical idea of having a shape that protrudes more than the flat part 200. The guide part 300 may protrude in a direction away from the electrode assembly 110. The pouch 120 may be located outside the guide part 300, and in some embodiments, the pouch 120 may not be located outside the guide part 300. If the pouch 120 is not located outside the guide part 300, the pouch 120 may be connected to the end of the guide part 300. The guide part 300 may be made of the same material as the flat part 200. The rigidity of the guide part 300 may be greater than that of the pouch 120, and if deformation occurs due to external force, the deformation of the pouch 120 may be greater than that of the guide part 300. The guide part 300 may be implemented in various modifications, such as being made of the same material as the pouch 120.

According to some embodiments, the flat part 200 may be used to be connected to the pouch 120 without the guide part 300. If only the flat part 200 is connected to the pouch 120 without the guide part 300, the guide part 300 and the pouch 120 may be made of the same material, and the guide part 300 and the pouch 120 may be molded to be integrated with each other.

The guide part 300 according to some embodiments may include an upper guide 310, a lower guide 320, a first side 330, and a second side 340. The upper guide 310 may be located above the flat part 200 to extend in the width direction y of the pouch 120. The upper guide 310 may protrude in the direction away from the electrode assembly 110 than the flat part 200.

The lower guide 320 may be installed in a shape facing the upper guide 310 with the flat part 200 therebetween. The lower guide 320 may be located below the flat part 200 to extend in the width direction y of the pouch 120 like the upper guide 310. The lower guide 320 may protrude in the direction away from the electrode assembly 110 than the flat part 200. Protruding lengths of the lower guide 320 and the upper guide 310 may be the same.

The first side 330 may face one end of the flat part 200 and may have a protrusion shape connecting the upper guide 310 to the lower guide 320. The first side 330 may connect one end of the upper guide 310 to one end of the lower guide 320.

The second side 340 may face the other end of the flat part 200 and may have a protrusion shape connecting the upper guide 310 to the lower guide 320. The second side 340 may connect the other end of the upper guide 310 to the other end of the lower guide 320.

The guide part 300 may be provided in a rectangular frame shape, and a cross-section of the guide part 300 may be provided in a “V” or “U” shape. According to some embodiments, because a guide groove 350 is defined inside the guide part 300, a storage space for the electrolyte may increase.

A length of the upper guide 310 in a vertical direction z may be referred to as a reference symbol T1. A length of the flat part 200 in the vertical direction z may be referred to as a reference symbol T2. A length of the lower guide 320 in the vertical direction z may be referred to as a reference symbol T3. A length of the first side 330 in the width direction y may be referred to as a reference symbol T4. A length of the second side 340 in the width direction y may be referred to as a reference symbol T5. A length of the pouch 120 in the vertical direction z may be referred to as a reference symbol MT. A length of the pouch 120 in the width direction y may be referred to as a reference symbol MW. A length of the flat part 200 in the width direction y may be referred to as a reference symbol PW.

The reference symbols T1 and T3 may be the same. Because the length of the upper guide 310 in the vertical direction z and the length of the lower guide 320 in the vertical direction z are the same, if the pouch 120 is deformed by the external force, the deformation of the pouch 120 adjacent to the upper guide 310 and the lower guide may be the same or similar.

The reference symbols T4 and T5 may be the same. Because the length of the first side 330 in the width direction y and the length of the second side 340 in the width direction y are the same, if the pouch 120 is deformed by the external force, the deformation of the pouch 120 adjacent to the first side 330 and the second side 340 may be the same or similar.

Following equation: MT=T1+T2+T3 may be set. The length of the pouch 120 in the vertical direction z may be the same as the sum of the length of the upper guide 310 in the vertical direction z, the length of the flat part 200 in the vertical direction z, and the length of the lower guide 320 in the vertical direction z.

For example, if the length of the pouch 120 in the vertical direction z is approximately 100, T1 may be set to approximately 1 to approximately 10, T2 may be set to approximately 80 to approximately 98, and T3 may be set to approximately 1 to approximately 10. According to some embodiments, the length of the upper guide 310 in the vertical direction z may be approximately 1% to approximately 10% of the total length of the pouch 120 in the vertical direction z. According to some embodiments, the length of the lower guide 320 in the vertical direction z in the total length of the pouch 120 in the vertical direction z may be approximately 1% to approximately 10%. According to some embodiments, the length of the flat part 200 in the vertical direction z in the total length of the pouch 120 in the vertical direction z may be approximately 80% to approximately 98%. An area of the upper guide 310 and the lower guide 320 may be less than that of the flat part 200.

Following equation: MW=PW+T4+T5 may be set. The length of the pouch 120 in the width direction y may be the same as the sum of the length of the flat part 200 in the width direction y, the length of the first side 330 in the width direction y, and the length of the second side 340 in the width direction y.

For example, if the length of the pouch 120 in the width direction y is approximately 100, T4 may be set to approximately 1 to approximately 10, PW may be set to approximately 80 to approximately 98, and T5 may be set to approximately 1 to approximately 10. According to some embodiments, the length of the first side 330 in the width direction y is approximately 1% to approximately 10% of the total length of the pouch 120 in the width direction y. According to some embodiments, the length of the second side 340 in the width direction y in the total length of the pouch 120 in the width direction y may be approximately 1% to approximately 10%. According to some embodiments, the length of the flat part 200 in the width direction y in the total length of the pouch 120 in the width direction y may be approximately 80% to approximately 98%.

Although it has been described that a single flat part 200 is installed, the shape and number of the flat parts 200 may vary in various manners. According to some embodiments, the flat part 200 may be provided in plurality, and the plurality of first parts 200 may be spaced apart from each other with the guide part 300 therebetween.

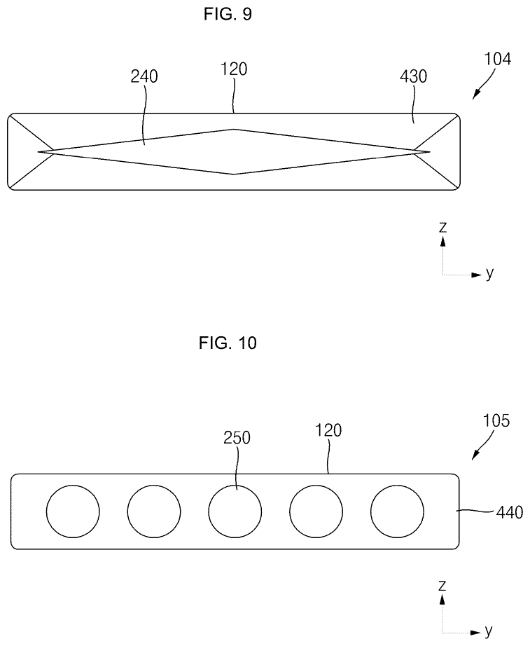

FIG. 6 illustrates a side view of a secondary battery 101 according to some embodiments. As illustrated in FIG. 6, a flat part 210 of the secondary battery 101 according to some embodiments may be provided in plurality and may be sequentially installed in a width direction y of the pouch 120.

The plurality of flat parts 210 may be provided in a square shape and may be installed to be spaced apart from each other in the width direction y. Because the guide part 400 is installed outside the flat part 210, the flat part 210 and the adjacent flat part 210 may be maintained to be spaced apart from each other.

Because configurations of the flat part 210 and the guide part 400 are the same or similar to that according to some embodiments, some repeated detailed descriptions of the same or similar components may be omitted.

FIG. 7 illustrates a side view of a secondary battery 102 according to some embodiments. As illustrated in FIG. 7, the secondary battery 102 according to some embodiments may include a single flat part 220. The flat part 220 may have an oval shape extending in a width direction y, and a guide part 410 may be installed around the flat part 220. Because configurations of the flat part 220 and the guide part 410 are the same or similar to that according to some embodiments, some repeated descriptions of the same or similar components may be omitted.

FIG. 8 illustrates a side view of a secondary battery 103 according to some embodiments. As illustrated in FIG. 8, the flat part 230 of the secondary battery 103 according to some embodiments may be arranged in a plurality of rows and installed to be spaced apart from each other in a width direction y.

The plurality of flat parts 230 may have a rectangular shape and be installed in two rows in a vertical direction z. According to some embodiments, the plurality of flat parts 230 may be installed to be spaced at an interval (e.g., a set or predetermined interval) from each other in the width direction y of the pouch 120. Because the guide part 420 is installed outside the flat part 230, the flat part 230 and the adjacent flat part 230 may be maintained to be spaced apart from each other.

Because configurations of the flat part 230 and the guide part 420 are the same or similar to that according to some embodiments, some repeated descriptions of the same or similar components may be omitted.

FIG. 9 illustrates a side view of a secondary battery 104 according to some embodiments. As illustrated in FIG. 9, the secondary battery 104 according to some embodiments may include a single flat part 240. The flat part 240 may have a diamond shape extending in a width direction y, and a guide part 430 may be installed around the flat part 240. Because configurations of the flat part 240 and the guide part 430 are the same or similar to that according to some embodiments, some repeated descriptions of the same or similar components may be omitted.

FIG. 10 illustrates a side view of a secondary battery 105 according to some embodiments. As illustrated in FIG. 10, a flat part 250 of the secondary battery 105 according to some embodiments may be provided in plurality and may be sequentially installed in a width direction y of the pouch 120.

The plurality of flat parts 250 may be provided in a circular shape and may be installed to be spaced apart from each other in the width direction y. Because the guide part 440 is installed outside the flat part 250, the flat part 250 and the adjacent flat part 250 may be maintained to be spaced apart from each other. Because configurations of the flat part 250 and the guide part 440 are the same or similar to that according to some embodiments, some repeated descriptions of the same or similar components may be omitted.

FIG. 11 illustrates a side view of a secondary battery 106 according to some embodiments. As illustrated in FIG. 11, the flat part 260 of the secondary battery 106 according to some embodiments may be arranged in a plurality of rows and installed successively in a width direction y.

The flat parts 260 arranged in two rows in a vertical direction z may extend in the width direction y of the secondary battery 106. The flat part 260 may have a strip-shaped rectangular shape. Because the guide part 450 is installed outside the flat part 260, the flat part 260 and the adjacent flat part 260 may be maintained to be spaced apart from each other.

Because configurations of the flat part 260 and the guide part 450 are the same or similar to that according to some embodiments, some repeated descriptions of the same or similar components may be omitted.

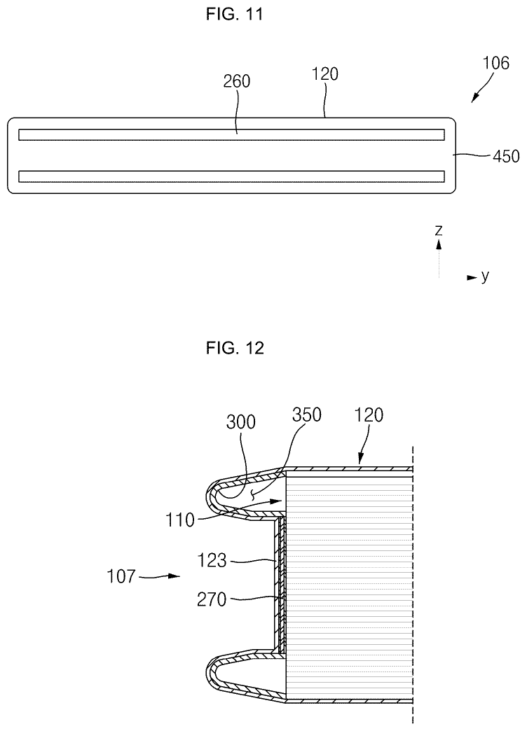

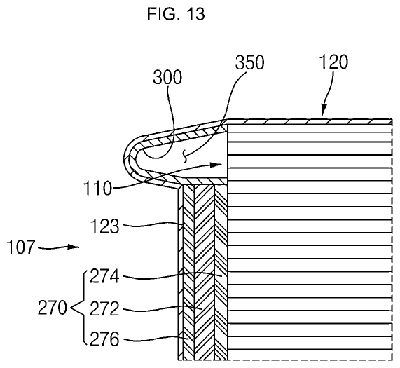

FIG. 12 illustrates a cross-sectional view of a state in which a flat part 270 is folded to an electrode assembly according to some embodiments, and FIG. 13 illustrates a cross-sectional view of a detailed configuration of the flat part 270 according to some embodiments. As illustrated in FIGS. 12 and 13, the flat part 270 of the secondary battery 107 according to some embodiments may be fixed to an end of an electrode assembly 110.

Because a configuration of a guide part 300 installed around an outer circumference of the flat part 270 are the same or similar to that according to some embodiments, some repeated descriptions of the same or similar components may be omitted.

For example, the flat part 270 may include an internal adhesive layer 274 adhering to an end of the other side of the electrode assembly 110 and a flat body 272 fixed to the internal adhesive layer 274 and connected to a pouch 120. Because the flat body 272 is the same as or similar to the flat part 270 according to some embodiments, some repeated description of the same or similar components may be omitted.

The internal adhesive layer 274 may be provided between the flat body 272 that maintains the shape of the pouch 120 and the end of the electrode assembly 110. According to some embodiments, an external adhesive layer 276 may be provided between the flat body 272 and the pouch 120. The internal adhesive layer 274 may be fixed to the flat body 272 and the electrode assembly 110. The external adhesive layer 276 may be fixed to the pouch 120 and the flat body 272. The internal adhesive layer 274 and the external adhesive layer 276 may be made of the same material, and the internal adhesive layer 274 will be described in more detail below.

Because the internal adhesive layer 274 has an area equal to or less than that of the other end of the electrode assembly 110, the internal adhesive layer 274 may be prevented from interfering with a guide part 300 and the pouch 120.

The internal adhesive layer 274 according to some embodiments may include any one of a thermosetting adhesive, a silicone adhesive, an acrylate adhesive, a urethane adhesive, a resin, and a rubber adhesive.

The thermosetting adhesive may be an adhesive that is cured by influences of heat and time and may have high resistance to the electrolyte. The epoxy adhesive may belong to the thermosetting adhesive and may maintain stability against the electrolyte.

The silicone adhesive have high chemical stability and thus may be used in a variety of environments. The silicone adhesive may have little interaction with the electrolyte to maintain stable attachment.

The acrylic adhesive may have a fast curing speed and excellent heat resistance and may be made of a chemically stable material.

The urethane adhesive may have excellent heat resistance and chemical resistance, but some types of urethane adhesives may have limited interaction with the electrolyte.

The rubber adhesive may be flexible and have high chemical resistance and thus may be used in a variety of environments. There may also be a rubber adhesive that has less interaction with the electrolyte.

Because the external adhesive has the same or similar configuration as the internal adhesive, some repeated description of the same or similar components may be omitted.

The secondary battery 100 according to some embodiments may include a folded structure that is capable of controlling deformation of the pouch 120 in a regular manner so that the pouch 120 is induced to be deformed in the regular manner to minimize or reduce instances of a phenomenon in which the end of the pouch is suctioned inward due to the reduction of the electrolyte. The folded structure may be provided by the flat part 200 and the guide part 300.

According to some embodiments of the present disclosure, the flat part and the guide part may be installed between the pouch and the electrode assembly to maintain the shape of the pouch, thereby minimizing or reducing instances of the phenomenon in which the end of the pouch is suctioned inward due to the reduction of the electrolyte.

However, the effects that are capable of being achieved through the present disclosure are not limited to the above-described effects, and other technical effects not mentioned can be clearly understood by those skilled in the art from the description of the invention described below.

The above-described embodiments are merely embodiments for carrying out the secondary battery 100, and the present invention is not limited to the embodiments specifically illustrated and described herein, and the technical spirit of the present invention include all ranges of technologies that may be variously modified by an ordinary person in the art, to which the present invention pertains, without departing from the essence of the present invention as claimed in the following claims, and their equivalents.

1 what is claimed is:

1. A secondary battery comprising:
an electrode assembly having a positive electrode plate, a negative electrode plate, and a separator between the positive electrode plate and the negative electrode plate;
a pouch having an inner space in which the electrode assembly is accommodated;
a flat part forming a plane on an end of the pouch; and
a guide part installed around the flat part and having a shape that protrudes further than the flat part.

2. The secondary battery as claimed in claim 1, wherein a tab is arranged in a direction of one side of the electrode assembly, and
the flat part and the guide part are arranged in a direction of the other side of the electrode assembly, which is a direction opposite to the tab.

3. The secondary battery as claimed in claim 1, wherein the flat part forms the plane in at least one of a circular, oval, polygonal, triangular, square, or rhombus shape.

4. The secondary battery as claimed in claim 1, wherein the flat part is provided in plurality, which are spaced apart from each other with the guide part therebetween.

5. The secondary battery as claimed in claim 1, wherein the flat part is provided in plurality, which are installed successively in a width direction of the pouch.

6. The secondary battery as claimed in claim 1, wherein the flat part is arranged in a plurality of rows, which are installed successively in a width direction of the pouch.

7. The secondary battery as claimed in claim 1, wherein the flat part extends in a width direction of the pouch and has a rectangular shape.

8. The secondary battery as claimed in claim 7, wherein the guide part comprises:
an upper guide above the flat part and extending in the width direction of the pouch;
a lower guide facing the upper guide with the flat part therebetween;
a first side facing an end of one side of the flat part and configured to connect the upper guide to the lower guide; and
a second side facing an end of the other side of the flat part and configured to connect the upper guide to the lower guide.

9. The secondary battery as claimed in claim 8, wherein, if a length of the upper guide in a vertical direction is T1, a length of the lower guide in the vertical direction is T3, a length of the first side in the width direction is T4, and a length of the second side in the width direction is T5, T1 and T3 are the same, and T4 and T5 are the same.

10. The secondary battery as claimed in claim 8, wherein, if a length of the upper guide in a vertical direction is T1, a length of the flat part in the vertical direction is T2, a length of the lower guide in the vertical direction is T3, and a length of the pouch in the vertical direction is MT, equation: MT=T1+T2+T3 is satisfied.

11. The secondary battery as claimed in claim 8, wherein, if a length of the upper guide in a vertical direction is T1, a length of the flat part in the vertical direction is T2, a length of the lower guide in the vertical direction is T3, and a length of the pouch in the vertical direction is 100, T1 is set to a value in a range of 1 to 10, T2 is set to a value in a range of 80 to 98, and T3 is set to a value in a range of 1 to 10.

12. The secondary battery as claimed in claim 11, wherein, if a length of the flat part in the width direction is PW, a length of the first side in the width direction is T4, a length of the second side in the width direction is T5, and a length of the pouch in the width direction is MW, equation: MW=PW+T4+T5 is satisfied.

13. The secondary battery as claimed in claim 12, wherein, if a length of the pouch in the width direction is 100, T4 is set to a value in a range of 1 to 10, PW is set to a value in a range of 80 to 98, and T5 is set to a value in a range of 1 to 10.

14. A secondary battery comprising:
an electrode assembly having a positive electrode plate, a negative electrode plate, and a separator between the positive electrode plate and the negative electrode plate;
a pouch having an inner space in which the electrode assembly is accommodated;
a flat part forming a plane on an end of the pouch; and
a guide part installed around the flat part and having a shape that protrudes further than the flat part,
wherein the flat part has rigidity greater than that of the pouch.

15. The secondary battery as claimed in claim 14, wherein the guide part has rigidity greater than that of the pouch.

16. The secondary battery as claimed in claim 14, wherein the pouch, the flat part, and the guide part are molded to be integrated with each other.

17. The secondary battery as claimed in claim 14, wherein the flat part is fixed to an end of the electrode assembly.

18. The secondary battery as claimed in claim 17, wherein the flat part comprises:
an internal adhesive layer adhering to an end of the other side of the electrode assembly; and
a flat body fixed to the internal adhesive layer and connected to the pouch.

19. The secondary battery as claimed in claim 18, wherein the internal adhesive layer comprises at least one of a thermosetting adhesive, a silicone adhesive, an acrylate adhesive, a urethane adhesive, a resin, or a rubber adhesive.

20. The secondary battery as claimed in claim 18, wherein the internal adhesive layer has an area equal to or less than that of the other end of the electrode assembly.
